(19) United States
(12) Patent Application Publication
(10) Pub. No.: US 2006/0162530 A1
(43) Pub. Date: Jul. 27, 2006

(54) Sounding body for musical instrument and method for making the sounding body

(75) Inventors: Shigeru Muramatsu, Shizuoka-ken (JP); Toshiro Sakai, Hamamatsu-shi (JP)

Correspondence Address: DICKSTEIN SHAPIRO MORIN & OSHINSKY LLP, 1177 AVENUE OF THE AMERICAS (6TH AVENUE), 41 ST FL., NEW YORK, NY, 10036-2714, US

(73) Assignee: Yamaha Corporation

(21) Appl. No.: 11/337,684

(22) Filed: Jan. 24, 2006

(30) Foreign Application Priority Data
Jan. 24, 2005 (JP) 2005-015824

(51) Int. Cl. G10D 13/08

(52) U.S. Cl. 84/402

(57) ABSTRACT

Reed includes a proximal end section, and an extension section extending straight in a forward direction from the proximal end section. The extension section has a distal end section and a thin plate portion, and the distal end section has a mass portion where much of the mass of the reed concentrates. The entire reed is formed of a single material, such as an SK material, by MIM molding. Small-thickness tuning piece 16 is provided integrally with the mass portion and extending downward from a front underside area of the mass portion. Tuning or tone pitch adjustment is carried out by cutting off a part of the tuning piece.

### BACKGROUND OF THE INVENTION

The present invention relates to sounding bodies, such as reeds, for use in music boxes or other musical instruments, and methods for making sounding bodies.

As disclosed, for example, in Japanese Patent Application Laid-open Publication Nos. 2002-116753 and HEI-5-35264, the conventional sounding bodies, such as reeds, for use in music boxes or other musical instruments are manufactured by outsert-molding a weight member, made of resin having a high density, directly on a vibrating plate to form an integral one-piece vibrating member and then cutting, via a multi-cutter, the vibrating member with the weight member into a comb-shaped reed structure (also known as “comb”) having a plurality of vibrating teeth or valves capable of vibrating independently of one another in correspondence with a plurality of scale notes. Each of the thus-formed vibrating valves has the weight on its free end portion and generates a tone with an assigned pitch by vibration of an extension section thereof extending from its proximal end section.

Tuning of each of such vibrating valves is carried out, for example, by grinding or cutting a relatively thin plate portion between the proximal end section and free end portion of the vibrating valve, as disclosed in the above-identified HEI-5-35264 publication. In some cases, the tuning of the vibrating valve is carried out by shaving a high-density portion of lead or other material provided on the free end portion.

However, when the sounding body is ground or cut for the tuning purpose, the tone pitch of the sounding body would vary due to heat produced by the grounding or cutting (hereinafter also referred to as “processing”); particularly, the thin plate portions of the vibrating valves tend to be greatly influenced by the produced heat. Thus, for accurate tuning, it is necessary to ground or cut the sounding body little by little while sufficiently cooling the sounding body and carefully checking the pitch of the tone generated by the sounding body in the cooled condition, which would undesirably result in poor workability. Besides, if the sounding body is subjected to additional processing in an insufficiently-cooled condition, for example, it would be difficult to carry out accurate tuning to a desired tone pitch. Particularly, in the case where each of the sounding bodies is formed by cutting the vibrating member as disclosed in the above-identified 2002-116753 publication, there arises a need to grind or cut (i.e., process) the individual sounding bodies to a considerable degree because the widths and other dimensions of the sounding bodies having just been formed (more specifically, workpieces of the sounding bodies) are not so accurate; thus, in this case, the heat problem would be very serious. Therefore, it has been difficult or impossible to readily obtain sounding bodies having a high tone pitch accuracy.

### SUMMARY OF THE INVENTION

In view of the foregoing, it is an object of the present invention to provide a sounding body for a musical instrument having a high tone pitch accuracy, and a method which can readily make such a sounding body.

In order to accomplish the above-mentioned object, the present invention provides an improved method for making a sounding body for use in a musical instrument, the sounding body including a proximal end section to be supported by a support structure, an extension section extending from the proximal end section, and a mass portion provided near a free end of the extension section, the sounding body being capable of generating a tone by the extension section vibrating with the proximal end section supported by the support structure. The method of the present invention is characterized by a forming step of forming the sounding body as an integral one-piece element, by MIM molding, using a single material.

According to the present invention, where the sounding body for a musical instrument is formed as an integral one-piece element by MIM molding, the sounding body can practically have a desired dimensional accuracy, and the vibrating section can practically have desired mass. Thus, not only the part to be removed from the MIM-molded sounding body (more specifically, MIM-molded workpiece of the sounding body), for the tuning purpose can be minimized, so that accurate tuning can be significantly facilitated. As a result, the method of the present invention can readily make a sounding body having a high tone pitch accuracy.

Preferably, the method of the present invention includes sintering and quenching the workpiece of the sounding body during the MIM molding while firmly clamping the workpiece in a predetermined direction to prevent deformation of the workpiece from occurring during the sintering or quenching. Such arrangements can effectively prevent undesired deformation, such as warpage and/or twisting, of the sounding body workpiece, thereby even further enhancing the tone pitch accuracy and tone color quality.

According to another aspect of the present invention, there is provided an improved sounding body for use in a musical instrument, which comprises: a proximal end section to be supported by a support structure; an extension section extending from the proximal end section; a mass portion provided near a free end of the extension section, the sounding body being capable of generating a tone by the extension section vibrating with the proximal end section supported by the support structure; and a small-thickness tuning piece formed integrally with the mass section to extend continuously therefrom. In the present invention, the sounding body is formed of a single material as an integral one-piece element.

According to the present invention thus arranged, tuning of the sounding body can be carried out by cutting off a part of the small-thickness tuning piece, by laser processing or the like, to change the mass of the mass portion. Thus, the present invention can significantly reduce heat production during the processing as compared to the conventional techniques where a great part has to be removed from the sounding body workpiece by grinding or cutting. Besides, because the small-thickness tuning piece is provided on the mass portion of the extension section, it is located remotely from a mainly-vibrating portion of the extension section between the mass portion and the proximal end section and can accomplish a good heat dissipation performance by virtue of its small thickness, head resulting from the processing of the small-thickness tuning piece has almost no influence on the mainly-vibrating portion of the extension section, which can minimize tone pitch variation due to the processing heat. Therefore, the tuning can be carried out with a high accuracy without providing a long cooling period after the processing, so that enhanced workability can be secured. As a result, the present invention can readily provide a sounding body for a musical instrument having a high tone pitch accuracy.

The following will describe embodiments of the present invention, but it should be appreciated that the present invention is not limited to the described embodiments and various modifications of the invention are possible without departing from the basic principles. The scope of the present invention is therefore to be determined solely by the appended claims.

### BRIEF DESCRIPTION OF THE DRAWINGS

For better understanding of the objects and other features of the present invention, its preferred embodiments will be described hereinbelow in greater detail with reference to the accompanying drawings, in which:

FIG. 1A is a side view of a sounding body for use in a musical instrument in accordance with a first embodiment of the present invention;

FIG. 1B is a perspective view of the sounding body;

FIG. 1C is an enlarged view showing a small-thickness tuning piece of the sounding body;

FIGS. 2A and 2B are schematic views explanatory of sintering and quenching steps during MIM molding; and

FIG. 3 is a perspective view of a second embodiment of the present invention.

### DETAILED DESCRIPTION OF THE INVENTION

### First Embodiment

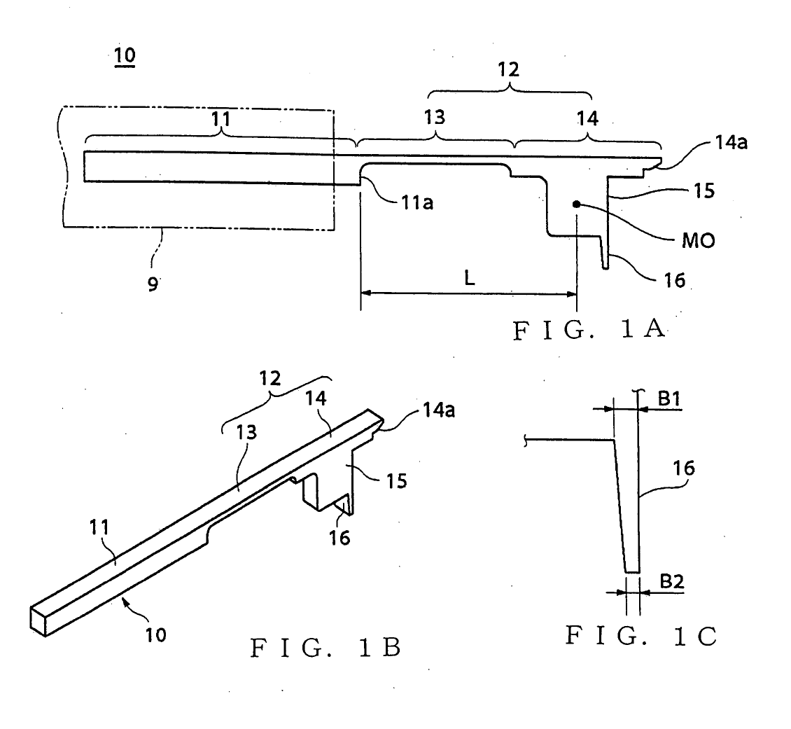

FIG. 1A is a side view of a sounding body for use in a musical instrument in accordance with a first embodiment of the present invention, FIG. 1B is a perspective view of the sounding body, and FIG. 1C is an enlarged view showing a small-thickness tuning piece of the sounding body. Hereinafter, a rightward direction in FIG. 1A is a direction toward the distal end, i.e. forward direction, of the sounding body.

The sounding body in these figures is constructed as a single reed for use in a music box. As seen in FIG. 1B, the reed 10 has a proximal end section 11, and an extension section 12 extending straight in the forward direction from the proximal end section 11. As viewed in plan, the reed 10 has an elongated, rectangular shape, and it has a uniform width generally throughout its full length. The extension section 12 has a free or distal end section 14, and a thin plate portion 13 connecting between the distal end section 14 and the proximal end section 11. The distal end section 14 includes a driven portion 14a, and a mass portion 15 where much of the mass of the reed 10 concentrates.

The thin plate portion 13 has a smaller vertical thickness than the proximal end section 11 and distal end section 14. The proximal end section 11 is fixedly supported by a fixing member (support structure) 9. As the driven portion 14a is played with a pick or the like (not shown) with the proximal end section 11 fixedly supported by the fixing member 9, mainly the thin plate portion 13 of the extension section 12 vibrates in the vertical direction to cause the distal end section 14 vibrates, and thus, the reed 10 generates a tone with a specific pitch assigned thereto.

The small-thickness tuning piece 16 is formed integrally with the mass portion 15 to project downward continuously from a front underside region of the mass portion 15. The tuning piece 16 has a small thickness in a front-and-rear direction of the reed 10 and tapers toward its lower end as shown in FIG. 1C. In the illustrated example, the greatest thickness B1, in the front-and-rear direction, at the proximal end of the tuning piece 16 is about 5 mm, while the smallest thickness B2, in the front-and-rear direction, at the distal end of the tuning piece 16 is about 3 mm. As will be later described, the entire reed 10, including the tuning piece 16, is formed, as an integral one-piece element, of a single material, such as an SK material, by metal injection molding (known as “MIM”).

In the illustrated example shown in FIGS. 1A to 1C, the reed 10 is one of a plurality of reeds employed in a single music box, and the specific pitch achievable by each of the reeds depends on the dimensions, such as the length and thickness, and shape of the reed, mass of the mass portion 15, etc. Thus, after completion of the molding, each of the reeds is individually subjected to minute adjustment of the tone pitch, i.e. tuning.

It is assumed here that the entire mass M(N) of the extension section 12 (including all portions located forwardly of the front end 11a of the proximal end section 11, such as the thin plate portion 13 and distal end section 14), vertically vibrating in response to playing of the driven portion 14a, concentrates at the center of mass M0, as seen in FIG. 1A. In FIG. 1A, reference character L represents a length (mm) from the front end 11a of the proximal end section 11 to the center of mass M0. If the bending rigidity of the thin plate portion 13 of the reed 10 is indicated by EI, then the tone pitch, i.e. tone generating frequency, of the reed 10 can be expressed by Mathematical Expression (1) below.
F=(1/2π)×√(3EI/ML³) (1)

Generally, tuning of a music box is carried out by shaving predetermined portions of the reeds while checking variation in the pitches of the respective tones generated by the reeds. For example, shaving a portion, corresponding to the thin plate portion 13, of any one of the reeds can lower the tone pitch, while shaving a portion, corresponding to the mass portion 15, of any one of the reeds can raise the tone pitch. However, because shaving these portions produces considerable heat (i.e., processing heat), the reed has to be cooled sufficiently each time the processing is carried out, which would result in a poor processing efficiency. Further, the cooling during each processing tends to be insufficient. For these reasons, the conventional tuning technique would undesirably result in a poor tuning accuracy.

Thus, in the instant embodiment of the present invention, the small-thickness tuning piece 16, projecting downward, is provided on the mass portion 15 of each of the reeds 10, so that desired tuning of the reed 10 can be carried out mainly by cutting off a part of the tuning piece 16. Because each of the molded reeds (more specifically, reed workpieces) 10 can have a high accuracy of form by virtue of the MIM molding, the instant embodiment permits sufficiently accurate tuning of each of the reeds 10 by processing of only a small portion of the reed 10, such as the tuning piece 16.

The processing of the tuning piece 16 is performed by cutting, via laser processing or the like, the piece 16 at a desired position measured or determined from its lower end. What influences the tone pitch is mainly heat of the thin plate portion 13. However, the laser cutting employed in the instant embodiment can considerably reduce the heat during the processing as compared to the conventional grinding or cutting. Besides, because the tuning piece 16 can accomplish a good heat dissipation performance by virtue of its small thickness and is located remotely from the thin plate portion 13, only an extremely small amount of the heat is conducted from the tuning piece 16 to the thin plate portion 13. Further, since the tuning piece 16 is remote from the front end 11a of the proximal end section 11, removing only a small part of the tuning piece 16 can change the position of the center of mass M0, and thus, it is possible to even further reduce the amount of the produced heat. Therefore, the tuning can be carried out with a high accuracy in a short time period, without giving any substantial consideration to influences of the heat and without providing any substantial cooling period.

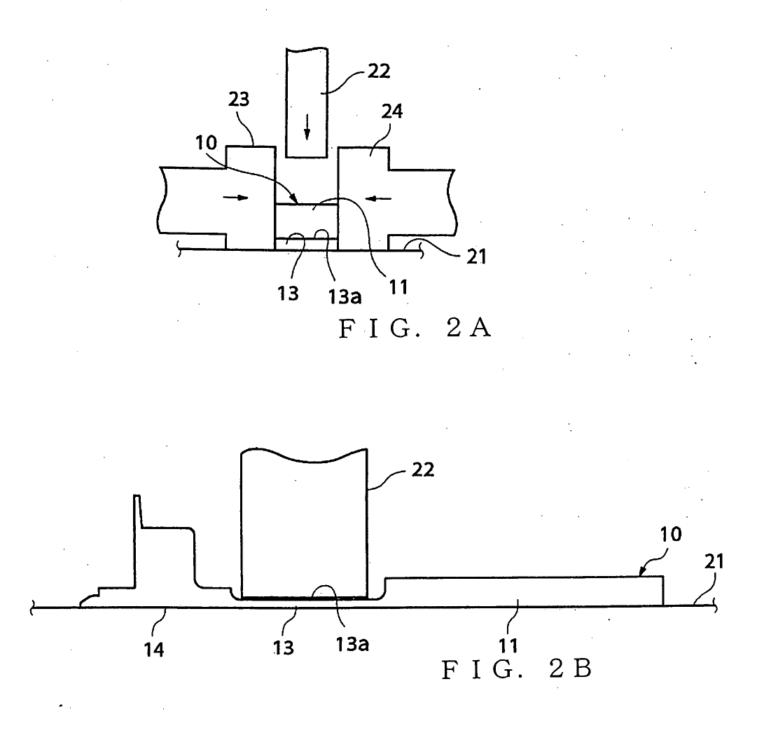

Next, a description will be given about an embodiment of a method for making the reed 10 in accordance with the embodiment of the present invention, with reference to FIGS. 2A and 2B. FIGS. 2A and 2B are schematic views explanatory of sintering and quenching steps during the MIM molding. More specifically, FIG. 2A is a front view of the reed 10 which particularly shows portions of the reed 10 located rearwardly of the thin plate portion 13, and FIG. 2B is a side view of the reed 10.

In the instant embodiment, the MIM molding generally includes the following steps:
(a) kneading;
(b) injection molding;
(c) debinding;
(d) sintering; and
(e) quenching.

First, powder or fine particles of the single material, SK material (e.g., SKH57), and thermoplastic binder are kneaded together at step (a). Then, the kneaded SK material particles and binder are injection-molded at step (b), debound by heating at step (c), and sintered and quenched at steps (d) and (e). Normally, sintering and quenching an injection-molded workpiece would produce undesired deformation, such as shrinkage, warpage and/or twisting, of the workpiece. Thus, the instant embodiment is arranged to tightly hold or clamp the workpiece of the reed (hereinafter also referred to as “reed workpiece”) 10 in the sintering and quenching steps.

Namely, as seen in FIG. 2A, the reed workpiece 10 is placed on a base 21 in an upside-down orientation, then left and right clamps 23 and 24 are moved toward each other to press the entire left and right side surfaces of the reed workpiece 10, and an upper clam 22 is moved downward to press the reverse surface 13a of the thin plate portion 13. In FIG. 2B, illustration of the left and right clamps 23 and 24 is omitted. Throughout the sintering and quenching, the pressing forces by the clamps 23, 24 and 22 are maintained to keep tightly clamping the reed workpiece 10, so that deformation of the reed workpiece 10 can be effectively prevented. Particularly, it is important to clamp the thin plate portion 13 in the vertical direction because the reed workpiece 10 may easily warp at the thin plate portion 13 in the vertical direction and may also easily twist at the thin plate portion 13. Even in a case where the reed workpiece 10 is clamped by the base 21 and upper clamp 22 alone, the reed workpiece 10 can be effectively prevented from being deformed at the thin plate portion 13.

The reed workpiece 10, having been appropriately formed into a desired shape, is then subjected to the tuning operation, where a part of the tuning piece 16 is cut off by the laser processing. In the above-described manner, a single completed reed 10 is provided. A plurality of other reeds 10, assigned to different tone pitches, are also formed into their respective lengths and shapes corresponding to the assigned tone pitches and then subjected to the tuning operation. All of the reeds 10 completed in the above-described manner are attached to their respective predetermined positions of the music box.

According to the instant embodiment, where each of the reeds 10 is formed of the single material as an integral one-piece element by the MIM molding, the reed 10 can practically have a desired dimensional accuracy and desired overall mass M represented by the mass of the mass portion 15. Thus, not only the part to be removed, by cutting or otherwise, for the tone pitch adjustment (i.e., tuning) purpose can be minimized, but also accurate tuning is permitted by just cutting off, through the laser processing, a part of the tuning piece 16 integrally formed with the mass portion 15. Consequently, the instant embodiment can significantly reduce the amount of heat produced by the processing, as compared to the conventional techniques where a great part has to be removed from the reed workpiece by cutting, grinding or otherwise. Further, because the tuning piece 16 is thin and remote from the thin plate portion 13, the tuning piece 16 has almost no substantial thermal influence on the thin plate portion 13. Because the instant embodiment can effectively prevent tone pitch variation from occurring due to heat production in the aforementioned manner, it permits accurate tuning and can eliminate a need for providing a long cooling period for the tuning after the processing. Consequently, the instant embodiment can achieve an enhanced workability, with the result that it can easily make reeds 10 each having a high tone pitch accuracy.

Although the tuning piece 16 may have any desired shape, it is preferable that the tuning piece 16 be formed into a small thickness. In an alternative, the tuning piece 16 may be provided to extend forwardly from the mass portion 15. Further, in order to minimize the part of the workpiece to be removed, it is preferable that the tuning piece 16 be located as remotely as possible from the front end 11a of the proximal end section 11. Further, in order to minimize the thermal influence on the tone pitch, it is preferable that the tuning piece 16 be located as remotely as possible from the thin plate portion 13.

### Second Embodiment

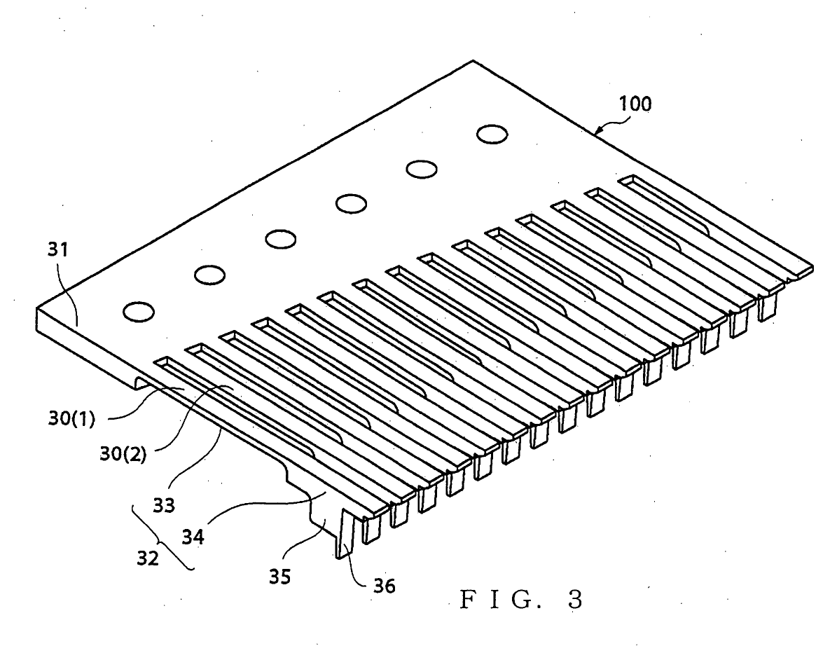

FIG. 3 is a perspective view of a second embodiment of the present invention. In the above-described first embodiment, the reeds 10 are each constructed as a single separate element. However, in the second embodiment, a plurality of reeds are constructed integrally as a comb-shaped reed structure 100.

The comb-shaped reed structure 100 comprises a common proximal end section 31, and a plurality of reeds 30 extending in the same direction from the common proximal end section 31. The reeds 30 are each similar in construction to the above-described reed 10, except that the reeds 30 extend from the common or same proximal end section 31. The extension section 32 of each of the reeds 30 has a free or distal end section 34, and a thin plate portion 33 connecting between the distal end section 34 and the proximal end section 31. The distal end section 34 has a mass portion 35, and a small-thickness tuning piece 36, similar to the small-thickness tuning piece 16, projects downwardly from a front underside region of the mass portion 35. Respective total lengths (i.e. extension lengths from the common proximal end section 31) of the plurality of reeds 30 differ from one another in correspondence with tone pitches assigned thereto.

Similarly to the reed 10 according to the first embodiment, the entire reed structure 100 is formed of a single material, such as an SK material, by MIM molding. Further, during the sintering and quenching steps, the thin plate portions 33 of the reed structure 100 are clamped in the vertical direction. After the MIM molding, tuning is carried out for each of the reeds 30. The reed structure 100 is attached to a predetermined position of the music box with the common proximal end section 31 fixedly supported by a predetermined support structure (not shown), so that the reeds 30 can be vibrated independently of one another to generate tones with the respective assigned pitches.

According to the instant embodiment of the present invention, there can be readily provided the reed structure 100 with the plurality of reeds 30 having a high tone pitch accuracy.

It should be appreciated that the reed structure 100, integrally including the plurality of reeds 30, is not limited to the above-described construction of the second embodiment where the reeds 30 extend in the same direction; for example, the reeds 30 may be formed to extend radially from the substantial center of the reed structure 100.

Further, in the present invention, the material of the reeds 10 or the reed structure 100 is not limited to the one as exemplified above, and the reeds 10 or the reed structure 100 may be formed of any other material as long as the material is suitably moldable by MIM molding.

Furthermore, if an extremely-high accuracy of form is achievable by the MIM molding, desired tone pitches may be accomplished, even without the tuning carried out, for example, by cutting off a part of the tuning piece 16 or 36. Particularly, in the case where the reeds of the invention are used in a music box or the like, there is a good possibility that particular tuning can be dispensed with.

Speaking of only the benefit that the tuning can be facilitated by allowing the heat, produced by the laser cutting or the like of the tuning piece 16, to have little influence on the thin plate portion 13, the reeds 10 or the reed structure 100 may be formed by any other suitable technique than the MIM molding. During the sintering and quenching of the molded reed workpiece, the reed 10 or reed structure 100 may be clamped in any suitable form than the above-described as long as the reed or reed structure 100 can be sintered and quenched while being clamped in predetermined directions to effectively avoid deformation of the reed or reed structure 100.

Finally, it should be appreciated that the sounding body of the present invention is not limited to the above-described reed 10, reed structure 100, etc. for use in musical instruments, such as music boxes.

What is claimed is:

1. A method for making a sounding body for use in a musical instrument, said sounding body including a proximal end section to be supported by a support structure, an extension section extending from the proximal end section, and a mass portion provided near a free end of the extension section, said sounding body being capable of generating a tone by the extension section vibrating with the proximal end section supported by the support structure, said method comprising
a forming step of forming said sounding body as an integral one-piece element, by MIM molding, using a single material.

2. A method as claimed in claim 1 which includes sintering and quenching a workpiece of said sounding body during the MIM molding, provided by said forming step, while clamping the workpiece in a predetermined direction to prevent deformation of the workpiece from occurring during the sintering or quenching.

3. A sounding body for use in a musical instrument comprising:
a proximal end section to be supported by a support structure;
an extension section extending from said proximal end section;
a mass portion provided near a free end of said extension section, said sounding body being capable of generating a tone by said extension section vibrating with said proximal end section supported by the support structure; and
a small-thickness tuning piece formed integrally with said mass section to extend continuously therefrom,
wherein said sounding body is formed of a single material as an integral one-piece element.
